(19) United States
(12) Patent Application Publication
(10) Pub. No.: US 2019/0349914 A1
(43) Pub. Date: Nov. 14, 2019

(54) DATA TRANSMISSION METHOD AND APPARATUS AND INFORMATION TRANSMISSION METHOD AND APPARATUS

(71) Applicant: HUAWEI TECHNOLOGIES CO., LTD., Shenzhen (CN)

(72) Inventors: Xiuqiang XU, Shanghai (CN); Yiqun WU, Shanghai (CN); Yan CHEN, Shanghai (CN)

(21) Appl. No.: 16/522,658

(22) Filed: Jul. 26, 2019

Related U.S. Application Data
(63) Continuation of application No. PCT/CN2018/074035, filed on Jan. 24, 2018.

(30) Foreign Application Priority Data
Jan. 26, 2017 (CN) 201710057505.5

(51) Int. Cl. H04W 72/04

(52) U.S. Cl. CPC H04W 72/044

(57) ABSTRACT

Embodiments provide a data transmission method and apparatus, and an information transmission method and apparatus. Under the data transmission method, obtaining time-frequency resources used to transmit first data can be obtained. Some or all of the time-frequency resources are used to transmit second data. A transmission parameter used to transmit the second data can also be obtained. A size of a to-be-encoded data block used to encode the first data can be determined based on the transmission parameter. The first data can be encoded based on the size of the to-be-encoded data block. A data block obtained through the encoding to the time-frequency resources can be mapped. In this way, interference caused by one type of data to another type of data can be reduced when same time-frequency resources are multiplexed for data transmission.

### CROSS-REFERENCE TO RELATED APPLICATIONS

This application is a continuation of International Application No. PCT/CN2018/074035, filed on Jan. 24, 2018, which claims priority to Chinese Patent Application No. 201710057505.5, filed on Jan. 26, 2017. The disclosures of the aforementioned applications are hereby incorporated by reference in their entireties.

### TECHNICAL FIELD

This application relates to the communications field, and more specifically, to a data transmission method and apparatus in the communications field.

### BACKGROUND

Enhanced mobile broadband (enhanced Mobile Broadband, eMBB) communications and ultra-reliable and low latency communications (ultra-reliable and low latency communications, URLLC) are two important scenarios in a future network system. Based on an existing mobile broadband service scenario, the eMBB can further improve performance such as system capacity, and enhance user experience, and eMBB services are mainly traffic-intensive mobile broadband services such as a 3D/an ultra high definition video. URLLC services are mainly unmanned driving, industrial automation, and the like that require ultra-reliable and low latency connections. Compared with eMBB service data, URLLC service data usually features a smaller data packet, for example, a size of the data packet ranges from dozens of bytes to hundreds of bytes.

Because the URLLC service data features random arrival, when the eMBB service data is transmitted in uplink by using a time-frequency resource, the URLLC service data may also be transmitted in uplink by using the time-frequency resource. In this case, the URLLC service data and the eMBB service data interfere with each other during reception.

### SUMMARY

This application provides a data transmission method and apparatus and an information transmission method and apparatus, to reduce interference caused by one type of data to another type of data when same time-frequency resources are multiplexed for data transmission.

According to a first aspect, this application provides a data transmission method, and the method includes:

obtaining time-frequency resources used to transmit first data, where some or all of the time-frequency resources are further used to transmit second data;

obtaining a transmission parameter used to transmit the second data;

determining, based on the transmission parameter, a size of a to-be-encoded data block used to encode the first data;

encoding the first data based on the size of the to-be-encoded data block; and

mapping a data block obtained through the encoding to the time-frequency resources.

In this embodiment, a TTI represents a time interval for one time of data transmission, and is also a minimum scheduling period. In 5G, eMBB service data and URLLC service data are usually transmitted by using TTIs of different sizes.

In this embodiment, a data block transmitted in a TTI is referred to as a transmit block, and a code block may be obtained after a transmit block in a TTI is modulated and encoded.

It should be understood that the data transmission method in this embodiment may be used in an uplink data transmission scenario, or may be used in a downlink data transmission scenario. In the uplink data transmission scenario, the data sending device may be a terminal device. In the downlink data transmission scenario, the data sending device may be a network device.

It should be further understood that the first data in this embodiment may be eMBB service data, the second data may be URLLC service data, and the first data and the second data may be transmitted by a same data sending device, or may be transmitted by different data sending devices.

In a possible implementation, the transmission parameter includes at least one of a size of a to-be-encoded data block used to transmit the second data, a quantity of transmission time intervals TTIs used to transmit the second data, a size of each TTI, a first frequency resource used to transmit the second data in each TTI, a time-frequency resource occupied by a control channel in each TTI, and a time-frequency resource occupied by a pilot in each TTI.

In some embodiments, the transmission parameter may include the size of the to-be-encoded data block used to transmit the second data, and the data sending device may use the size of the to-be-encoded data block used by the second data as the size of the to-be-encoded data block used to encode the first data.

In some embodiments, if the TTIs used to transmit the second data occupy all time domain resources of the first data, the transmission parameter may include only the size of the TTI, and the data sending device may determine, based on the size of the TTI, a size of a to-be-encoded data block used to encode the second data, and use the size of the to-be-encoded data block used to encode the second data as the size of the to-be-encoded data block used to encode the first data.

It should be understood that, in this embodiment, all or some of the first frequency resources used to transmit the first data in the TTIs may be used to transmit the second data. This is not limited in this embodiment.

According to the data transmission method provided in this embodiment, because the size of the to-be-encoded data block used to encode the first data is determined based on the transmission parameter used to transmit the second data, when the second data is transmitted on the time-frequency resources used to transmit the first data, interference of the second data in the first data is limited to some code blocks of the first data. This reduces the interference of the second data in the first data.

In addition, the data sending device determines, based on the size of each TTI, a frequency domain resource corresponding to each TTI, the time-frequency resource occupied by the control channel in each TTI, and the time-frequency resource occupied by the pilot in each TTI, the size of the to-be-encoded data block used to encode the first data, and encodes and maps the first data based on the size of the to-be-encoded data block. This allows a data receiving device to decode, based on the size of each TTI, the frequency domain resource corresponding to each TTI, the time-frequency resource occupied by the control channel in each TTI, and the time-frequency resource occupied by the pilot in each TTI, both a data block of the first data and a data block of the second data that are received in each TTI, thereby improving data transmission reliability.

In the data transmission method in this embodiment, the transmission parameter carries the time-frequency resource occupied by the control channel in each TTI and/or the time-frequency resource occupied by the pilot in each TTI, so that symbols occupied by a pilot and/or a control channel of the second data can be avoided when the first data is transmitted. This avoids affecting normal transmission of the second data.

In another possible implementation, the determining, based on the transmission parameter, a size of a to-be-encoded data block used to encode the first data includes: determining, based on the size of each TTI and the first frequency resource used to transmit the second data in each TTI, a size of a to-be-encoded data block corresponding to each TTI; and determining, based on the size of the to-be-encoded data block corresponding to each TTI, the size of the to-be-encoded data block used to encode the first data.

In some embodiments, the transmission parameter may include the quantity of TTIs used to transmit the second data, the size of each TTI, and the first frequency resource used to transmit the second data in each TTI, and the data sending device may determine, based on the size of each TTI and the first frequency resource used to transmit the second data in each TTI, the size of the to-be-encoded data block corresponding to each TTI.

In still another possible implementation, before the determining, based on the size of the to-be-encoded data block corresponding to each TTI, the size of the to-be-encoded data block used to encode the first data, the method further includes: determining, based on the first frequency resource used to transmit the second data in each TTI, a second frequency resource that is in the time-frequency resources and that is not used to transmit the second data; and determining, based on the second frequency resource and TTIs corresponding to the time-frequency resources, a size of a to-be-encoded data block used to encode data that is in the first data and that is transmitted by using the second frequency resource; and correspondingly, the determining, based on the size of the to-be-encoded data block corresponding to each TTI, the size of the to-be-encoded data block used to encode the first data includes: determining, based on the size of the to-be-encoded data block corresponding to each TTI and the size of the to-be-encoded data block used to encode the data that is in the first data and that is transmitted by using the second frequency resource, the size of the to-be-encoded data block used to encode the first data.

In still another possible implementation, the determining, based on the size of each TTI and the first frequency resource used to transmit the second data in each TTI, a size of a to-be-encoded data block corresponding to each TTI includes: determining, based on a first frequency resource used to transmit the second data in an i^{th} TTI in the TTIs, a size of a to-be-encoded data block corresponding to a reference TTI when the i^{th} TTI corresponds to a size of the reference TTI, where i is an integer greater than 0; and determining, based on the size of the to-be-encoded data block corresponding to the reference TTI and a size of the i^{th} TTI, a size of a to-be-encoded data block corresponding to the i^{th} TTI.

It should be understood that the reference TTI may be, for example, a TTI of 14 symbols corresponding to a TBS in the prior art.

In still another possible implementation, the size of the to-be-encoded data block corresponding to the i^{th} TTI is N_{i-CBS}, and N_{i-CBS} is determined according to the following formula:

N_{i-CBS}=floor(N_{j-CBS}·N_{i-OS}/N_{j-OS}), where

N_{j-OS} is the size of the reference TTI, N_{i-OS} is the size of the i^{th} TTI, N_{j-CBS} is the size of the to-be-encoded data block corresponding to the reference TTI, and floor (.) indicates rounding down.

In still another possible implementation, the determining, based on the size of each TTI and the first frequency resource used to transmit the second data in each TTI, a size of a to-be-encoded data block corresponding to each TTI includes: determining, based on a size of an i^{th} TTI in the TTIs, the first frequency resource used to transmit the second data in the i^{th} TTI, and a pre-stored first mapping relationship, a size of a to-be-encoded data block corresponding to the i^{th} TTI, where the first mapping relationship includes a mapping relationship between a size of a TTI and a frequency resource and a size of a to-be-encoded data block, and i is an integer greater than 0.

In some embodiments, the data sending device may pre-store a TBS table, where the TBS table includes the mapping relationship between a size of a TTI and a frequency resource and a size of a to-be-encoded data block.

In still another possible implementation, the obtaining time-frequency resources used to transmit first data includes: receiving first indication information sent by a network device, where the first indication information is used to indicate the time-frequency resources.

In some embodiments, the data sending device may be a terminal device, and the terminal device may receive the first indication information that is sent by the network device and that is used to indicate the time-frequency resources.

In still another possible implementation, the first indication information further includes frequency hopping information, where the frequency hopping information is used to indicate a distribution status in terms of time of a frequency resource that is in the time-frequency resources and that is used to transmit the second data.

In some embodiments, the first indication information further includes frequency hopping information, and the data sending device may learn, based on the frequency hopping information, the size of each TTI and a frequency resource used to transmit the second data in each TTI.

In still another possible implementation, the obtaining a transmission parameter used to transmit the second data includes: receiving the transmission parameter sent by the network device.

In still another possible implementation, the method further includes: receiving second indication information sent by the network device, where the second indication information is used to instruct to enable the time-frequency resources to transmit the first data.

According to the data transmission method provided in this embodiment, after receiving the second indication information, the data sending device enables the time-frequency resources to transmit the first data, that is, determines, based on the transmission parameter used to transmit the second data, the size of the to-be-encoded data block used to encode the first data, and encodes and maps the first data based on the size of the to-be-encoded block. If the data sending device does not receive the second indication information, the data sending device encodes and maps the first data based on a size of a to-be-encoded data block used to transmit the first data in the prior art.

In still another possible implementation, the method further includes: sending, to a device that is to receive the first data, information used to indicate the time-frequency resources; and/or sending the transmission parameter to the device that is to receive the first data.

In some embodiments, the data sending device may be a network device. After determining the time-frequency resources and the transmission parameter that is used to transmit the second data, the network device may send, to a terminal device, the transmission parameter and/or the information used to indicate the time-frequency resources, so that the terminal device encodes and maps the first data based on the indication information and the transmission parameter.

According to a second aspect, this application provides an information transmission method, and the method includes:

determining, by a network device, time-frequency resources used to transmit first data, where some or all of the time-frequency resources are further used to transmit second data; and

sending, to a device that is to transmit the first data, information used to indicate the time-frequency resources, and a transmission parameter used to transmit the second data.

According to the data transmission method provided in this embodiment, after determining the time-frequency resources and the transmission parameter that is used to transmit the second data, the network device may send, to the device that is to transmit the first data, the transmission parameter and/or the information used to indicate the time-frequency resources, so that the device encodes and maps the first data based on the indication information and the transmission parameter.

In a possible implementation, the transmission parameter includes at least one of a size of a to-be-encoded data block used to transmit the second data, a quantity of transmission time intervals TTIs used to transmit the second data, a size of each TTI, a first frequency resource used to transmit the second data in each TTI, a time-frequency resource occupied by a control channel in each TTI, and a time-frequency resource occupied by a pilot in each TTI.

According to a third aspect, this application provides another data transmission method, and the method includes:

obtaining time-frequency resources used to transmit first data, where some or all of the time-frequency resources are further used to transmit second data;

obtaining a transmission parameter used to transmit the second data;

determining, based on the transmission parameter, a size of a to-be-decoded data block used to decode the first data; and

receiving, based on the size of the to-be-decoded data block, a to-be-decoded data block of the first data by using the time-frequency resources.

According to the data transmission method provided in this embodiment, a data sending device independently encodes a to-be-encoded data block corresponding to each TTI, and maps encoded data blocks to the time-frequency resources. Therefore, after receiving each to-be-decoded data block, a data receiving end may decode the decoded data block, thereby reducing a decoding delay.

In a possible implementation, the transmission parameter includes at least one of a size of a to-be-encoded data block used to transmit the second data, a quantity of transmission time intervals TTIs used to transmit the second data, a size of each TTI, a first frequency resource used to transmit the second data in each TTI, a time-frequency resource occupied by a control channel in each TTI, and a time-frequency resource occupied by a pilot in each TTI.

According to a fourth aspect, this application provides a data transmission apparatus, configured to perform the method in the first aspect or in various implementations of the first aspect. Specifically, the apparatus includes units configured to perform the method in the first aspect or in various implementations of the first aspect.

According to a fifth aspect, this application provides an information transmission apparatus, configured to perform the method in the second aspect or in various implementations of the second aspect. Specifically, the apparatus includes units configured to perform the method in the second aspect or in various implementations of the second aspect.

According to a sixth aspect, this application provides another data transmission apparatus, configured to perform the method in the second aspect or in various implementations of the second aspect. Specifically, the apparatus includes units configured to perform the method in the third aspect or in various implementations of the third aspect.

According to a seventh aspect, this application provides still another data transmission apparatus, including a processor and a transceiver, where the processor performs the method in the first aspect or in various implementations of the first aspect based on the transceiver.

According to an eighth aspect, this application provides still another information transmission apparatus, including a processor and a transceiver, where the processor performs the method in the second aspect or in various implementations of the second aspect based on the transceiver.

According to a ninth aspect, this application provides still another data transmission apparatus, including a processor and a transceiver, where the processor performs the method in the third aspect or in various implementations of the third aspect based on the transceiver.

According to a tenth aspect, this application provides a computer readable medium, configured to store a computer program, where the computer program includes an instruction used to perform the method in the first aspect or in various implementations of the first aspect.

According to an eleventh aspect, this application provides another computer readable medium, configured to store a computer program, where the computer program includes an instruction used to perform the method in the second aspect or in various implementations of the second aspect.

According to a twelfth aspect, this application provides another computer readable medium, configured to store a computer program, where the computer program includes an instruction used to perform the method in the third aspect or in various implementations of the third aspect.

According to a thirteenth aspect, this application provides a computer program product that includes an instruction, and when the computer program product runs on a computer, the computer is enabled to perform the method in the first aspect or in various implementations of the first aspect.

According to a fourteenth aspect, this application provides a computer program product that includes an instruction, and when the computer program product runs on a computer, the computer is enabled to perform the method in the second aspect or in various implementations of the second aspect.

According to a fifteenth aspect, this application provides a computer program product that includes an instruction, and when the computer program product runs on a computer, the computer is enabled to perform the method in the third aspect or in various implementations of the third aspect.

### DESCRIPTION OF DRAWINGS

FIG. 1 is a schematic architectural diagram of a wireless communications system to which various embodiments are applied;

FIG. 2 is a schematic flowchart of a data transmission method according to an embodiment;

FIG. 3 is a schematic flowchart of an information transmission method according to an embodiment;

FIG. 4 is a schematic diagram of a multiplexed resource according to an embodiment;

FIG. 5 is a schematic diagram of another multiplexed resource according to an embodiment;

FIG. 6 is a schematic structural diagram of a pilot location according to an embodiment;

FIG. 7 is a schematic structural diagram of a control channel location according to an embodiment;

FIG. 8 is a schematic block diagram of a data transmission apparatus according to an embodiment;

FIG. 9 is a schematic block diagram of another information transmission apparatus according to an embodiment;

FIG. 10 is a schematic block diagram of still another data transmission apparatus according to an embodiment; and

FIG. 11 is a schematic block diagram of another information transmission apparatus according to an embodiment.

### DESCRIPTION OF EMBODIMENTS

The following describes technical solutions of this application with reference to the accompanying drawings.

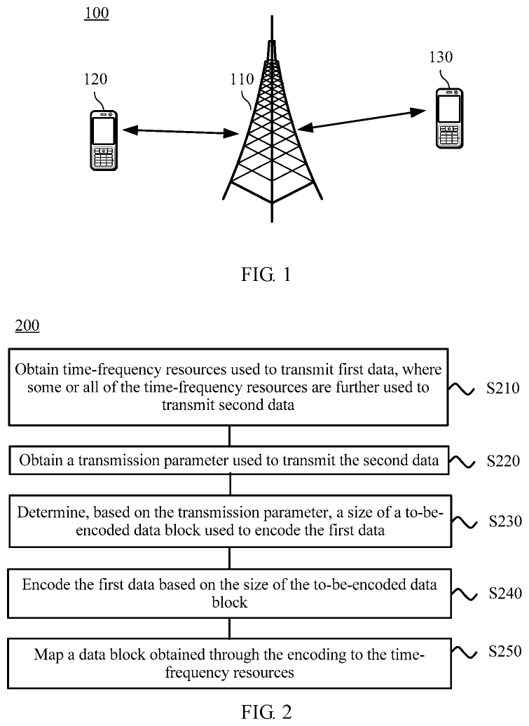

FIG. 1 shows a wireless communications system 100 to which the various embodiments are applied. The wireless communications system 100 may include at least one network device. FIG. 1 shows a network device 110. The network device 110 may provide communication coverage for a specific geographic area, and may communicate with a terminal device located in the coverage area. The network device 110 may be a base transceiver station (base transceiver station, BTS) in a GSM system or a CDMA system, a nodeB (nodeB, NB) in a WCDMA system, an evolved NodeB (evolved NodeB, eNB or eNodeB) in an LTE system, or a radio controller in a cloud radio access network (cloud radio access network, CRAN). The network device may alternatively be a relay station, an access point, an in-vehicle device, a wearable device, a network-side device in a future 5G network, a network device in a future evolved public land mobile network (public land mobile network, PLMN), or the like.

The wireless communications system 100 further includes a plurality of terminal devices located in coverage of the network device 110. FIG. 1 shows a terminal device 120 and a terminal device 130.

FIG. 1 shows one network device and two terminal devices as an example. In some embodiments, the wireless communications system 100 may include a plurality of network devices, and another quantity of terminal devices may be included in coverage of each network device. This is not intended to be limiting. In some embodiments, the wireless communications system 100 may further include another network entity, such as a network controller and a mobility management entity. The various embodiments are not limited thereto.

It should be understood that, in various embodiments, the terminal device may be mobile or fixed. The first terminal device 120 and the second terminal device 130 may be access terminals, user equipment (user equipment, UE), subscriber units, subscriber stations, mobile stations, mobile consoles, remote stations, remote terminals, mobile devices, user terminals, terminals, radio communications equipment, user agents, user apparatuses, or the like. The access terminal may be a cellular phone, a cordless phone, a Session Initiation Protocol (session initiation protocol, SIP) phone, a wireless local loop (wireless local loop, WLL) station, a personal digital assistant (personal digital assistant, PDA), a handheld device having a wireless communication function, a computing device, another processing device connected to a wireless modem, an in-vehicle device, a wearable device, a terminal device in the future 5G network, or a terminal device in the future evolved PLMN.

In various embodiments, a TTI represents a time interval for one time of data transmission, and is a minimum scheduling period. In the 5G, eMBB service data and URLLC service data are usually transmitted by using different TTI sizes. For ease of understanding, in this application, the “eMBB service data” is referred to as “eMBB data”, and the “URLLC service data” is referred to as “URLLC data”.

In various embodiments, a data transmission device may transmit the eMBB data and/or the URLLC data. Because a data packet of the URLLC data is usually smaller than a data packet of the eMBB data, a TTI of eMBB is usually greater than or equal to a TTI of URLLC.

In the various embodiments, a data block transmitted by a data sending device in a TTI is referred to as a transmit block (transmit block, TB), and a size of the transmit block is referred to as a transmit block size (transmit block size, TBS). A code block (code block, CB) may be obtained after a transmit block in a TTI is modulated and encoded.

Before sending data, the data sending device may learn a modulation and coding scheme (modulation and coding, MCS) number of a to-be-transmitted transmit block and a number of a preallocated physical resource block, obtain a corresponding TBS number through querying based on the MCS number, obtain a TBS table corresponding to the TBS number, obtain a TBS from the TBS table based on a quantity of the physical resource blocks, determine a to-be-transmitted TB based on the TBS, perform modulation and coding on the TB based on the MCS of the TB to obtain a CB, and then map the CB to a physical resource corresponding to the number of the physical resource block.

In addition, in the prior art, when a data receiving device is receiving an eMBB CB on an allocated physical resource, if another device multiplexes a part or all of the physical resource to transmit a URLLC CB, because URLLC data interferes with eMBB data received by the data receiving device on the multiplexed part of the physical resource, a code block of the URLLC data interferes with a code block of the received eMBB data. In the prior art, a size of the code block of eMBB is far larger than a size of the code block of the URLLC data. Consequently, the relatively small code block of URLLC interferes with the relatively large data block of the eMBB data. Therefore, a relatively high bit error rate is caused when the code block of the received eMBB data is decoded.

According to a data transmission method in an embodiment, a data sending device can determine a size of a to-be-encoded data block of eMBB data based on a transmission status of URLLC data, and encode and map the eMBB data based on the size of the to-be-encoded data block of the eMBB data. In this case, on a multiplexed part of a physical resource, the size of the to-be-encoded data block of the eMBB data can better match a size of a to-be-encoded data block of the URLLC data. Therefore, when a data receiving device decodes the eMMB data, interference of the URLLC data in the eMBB data is limited to a relatively small data range. This reduces the interference of the URLLC data in the eMBB data.

In addition, when decoding a code block of the URLLC data, a code block of the eMBB data that interferes with the code block needs to be read. Because on the multiplexed part of the physical resource, the size of the to-be-encoded data block of the eMBB data can better match the size of the to-be-encoded data block of the URLLC data, a size of the code block of the eMBB data can also better match a size of the code block of the URLLC data. This reduces a decoding delay generated when the code block of the URLLC data is being decoded.

FIG. 2 is a schematic flowchart of a data transmission method 200 according to an embodiment. The method 200 may be applied to, for example, the wireless communications system shown in FIG. 1. It should be understood that the method 200 may be performed by a data sending device.

S210. Obtain time-frequency resources used to transmit first data, where some or all of the time-frequency resources are further used to transmit second data.

S220. Obtain a transmission parameter used to transmit the second data.

S230. Determine, based on the transmission parameter, a size of a to-be-encoded data block used to encode the first data.

S240. Encode the first data based on the size of the to-be-encoded data block.

S250. Map a data block obtained through the encoding to the time-frequency resources.

It should be understood that the data transmission method in this embodiment may be used in an uplink data transmission scenario, or may be used in a downlink data transmission scenario. In the uplink data transmission scenario, the data sending device may be a terminal device. In the downlink data transmission scenario, the data sending device may be a network device. It should be further understood that the first data in this embodiment may be eMBB data, the second data may be URLLC data, and the first data and the second data may be transmitted by a same data sending device, or may be transmitted by different sending devices.

In this embodiment, the to-be-encoded data block may be a TB, or may be a data block that is obtained by dividing a TB and that is to be input to an encoder.

According to the data transmission method in this embodiment, the data sending device can determine the size of the to-be-encoded data block of the eMBB data based on a transmission status of the URLLC data, and encode and map the eMBB data based on the size of the to-be-encoded data block of the eMBB data. In this case, on a multiplexed part of a physical resource, the size of the to-be-encoded data block of the eMBB data can better match a size of a to-be-encoded data block of the URLLC data. Therefore, when a data receiving device decodes the eMMB data, interference of the URLLC data in the eMBB data is limited to a relatively small data range. This reduces the interference of the URLLC data in the eMBB data.

In addition, when decoding a code block of the URLLC data, a code block of the eMBB data that interferes with the code block needs to be read. Because on the multiplexed part of the physical resource, the size of the to-be-encoded data block of the eMBB data can better match the size of the to-be-encoded data block of the URLLC data, a size of the code block of the eMBB data can also better match a size of the code block of the URLLC data. This reduces a decoding delay generated when the code block of the URLLC data is being decoded.

In some embodiments, the transmission parameter in S220 may include at least one of a size of a to-be-encoded data block used to transmit the second data, a quantity of TTIs used to transmit the second data, a size of each TTI, a first frequency resource used to transmit the second data in each TTI, a time-frequency resource occupied by a control channel in each TTI, and a time-frequency resource occupied by a pilot in each TTI. This is not limited in this embodiment.

According to the data transmission method provided in this embodiment, the size of the to-be-encoded data block that is used to encode the first data and that is determined based on at least one of the quantity of TTIs used to transmit the second data, the size of each TTI, the first frequency resource used to transmit the second data in each TTI, the time-frequency resource occupied by the control channel in each TTI, and the time-frequency resource occupied by the pilot in each TTI actually better matches the size of the to-be-encoded data block used to transmit the second data. In addition, the first data is encoded and mapped based on the size of the to-be-encoded data block. This limits the interference of the URLLC data in the eMBB data to a relatively small data range when the eMBB data is received, and can further reduce a decoding delay when the URLLC data is received.

In one embodiment, the transmission parameter may include the size of the to-be-encoded data block used to transmit the second data. The data sending device may determine, based on the size of the to-be-encoded data block used to transmit the second data, the size of the to-be-encoded data block used to encode the first data.

In some embodiments, in this embodiment, all or some of the first frequency resources used to transmit the first data in the TTIs may be used to transmit the second data. This is not limited in this embodiment.

In one embodiment, the transmission parameter may include the size of each TTI and the first frequency resource used to transmit the second data in each TTI. The data sending device may determine, based on the size of each TTI and the first frequency resource used to transmit the second data in each TTI, a size of a to-be-encoded data block corresponding to each TTI, and determine, based on the size of the to-be-encoded data block corresponding to each TTI, the size of the to-be-encoded data block used to encode the first data.

In another embodiment, if some of the first frequency resources used to transmit the first data in the TTIs are used to transmit the second data, the transmission parameter may include the quantity of TTIs used to transmit the second data, the size of each TTI, and the first frequency resource used to transmit the second data in each TTI. The data sending device may determine, based on the first frequency resource used to transmit the second data in each TTI, a second frequency resource that is in the time-frequency resources and that is not used to transmit the second data, determine, based on the second frequency resource and TTIs corresponding to the time-frequency resources, a size of a to-be-encoded data block used to encode data that is in the first data and that is transmitted by using the second frequency resource, and determine, based on the size of the to-be-encoded data block corresponding to each TTI and the size of the to-be-encoded data block used to encode the data that is in the first data that and that is transmitted by using the second frequency resource, the size of the to-be-encoded data block used to encode the first data.

In still another embodiment, if the TTIs used to transmit the second data occupy all time domain resources of the first data, the transmission parameter may include the size of the TTI. Correspondingly, the data sending device may determine, based on the size of the TTI, a size of a to-be-encoded data block used to encode the second data, and determine, based on the size of the to-be-encoded data block used to encode the second data, the size of the to-be-encoded data block used to encode the first data.

In some embodiments, the data sending device may determine, in different manners, a size of a to-be-encoded data block corresponding to an i^{th} TTI in the TTIs. The following describes in detail a method for determining, by the data sending device, the size of the to-be-encoded data block corresponding to the i^{th} TTI in this embodiment.

In one embodiment, the data sending device may determine, based on a first frequency resource used to transmit the second data in the i^{th} TTI in the TTIs, a size of a to-be-encoded data block corresponding to a reference TTI when the i^{th} TTI corresponds to a size of the reference TTI, where i is an integer greater than 0; and determine, based on the size of the to-be-encoded data block corresponding to the reference TTI and a size of the i^{th} TTI, the size of the to-be-encoded data block corresponding to the i^{th} TTI.

For example, the data sending apparatus may determine, based on an MCS index used to transmit the second data in the i^{th} TTI, a TBS index used to transmit the second data in the i^{th} TTI when the i^{th} TTI corresponds to the size of the reference TTI, obtain a TBS table and the first frequency resource used to transmit the second data in the i^{th} TTI, search the TBS table for the size of the to-be-encoded data block corresponding to the reference TTI, and then calculate, based on the size of the to-be-encoded data block corresponding to the reference TTI and the size of the i^{th} TTI, the size of the to-be-encoded data block corresponding to the i^{th} TTI.

Table 1 shows the TBS table corresponding to the reference TTI. It should be understood that the size of the reference TTI may be, for example, 14 symbols.

TABLE 1

| | | | | | | | | | | | |
|---|---|---|---|---|---|---|---|---|---|---|---|
| I_{TBS} | Bandwidth | 1 | 2 | 3 | 4 | 5 | 6 | 7 | 8 | 9 | . . . |
| | (Mbps) | | | | | | | | | | |
| 1 | TBS (bit) | 16 | 32 | 56 | 88 | 120 | 152 | 176 | 208 | 224 | . . . |

As shown in Table 1, I_{TBS} indicates the TBS index. Assuming that bandwidth corresponding to the i^{th} TTI is 9 Mbps, that the size of the to-be-encoded data block corresponding to the reference TTI is 224 bits can be obtained based on the TBS table corresponding to the reference TTI.

In some embodiments, assuming that the size of the to-be-encoded data block corresponding to the i^{th} TTI is N_{i-CBS}, N_{i-CBS} may be determined according to a formula (1):

N_{i-CBS}=floor(N_{j-CBS}·N_{i-OS}/N_{j-OS}) (1), where

N_{j-OS} is the size of the reference TTI, N_{i-OS} is the size of the i^{th} TTI, N_{j-CBS} is the size of the to-be-encoded data block corresponding to the reference TTI, and floor (.) indicates rounding down.

For example, assuming that the size of the reference TTI is 14 symbols, a TBS corresponding to the reference TTI is 224 bits, and the size of the i^{th} TTI is two symbols, the size of the to-be-encoded data block corresponding to the i^{th} TTI may be floor(224*2/14).

In another embodiment, the data sending device may alternatively determine, based on the size of the i^{th} TTI in the TTIs, the first frequency resource used to transmit the second data in the i^{th} TTI, and a pre-stored first mapping relationship, the size of the to-be-encoded data block corresponding to the i^{th} TTI, where the first mapping relationship includes a mapping relationship between a size of a TTI and a frequency resource and a size of a to-be-encoded data block, and i is an integer greater than 0.

For example, the data sending device may pre-store the TBS table shown in Table 2. The TBS table includes the mapping relationship between a size of a TTI and a frequency resource and a size of a to-be-encoded data block.

TABLE 2

| | | | | | | | | | | | | |
|---|---|---|---|---|---|---|---|---|---|---|---|---|
| I_{TBS} | Two | Bandwidth | 1 | 2 | 3 | 4 | 5 | 6 | 7 | 8 | 9 | . . . |
| 1 | symbols | (Mbps) | | | | | | | | | | |
| | | TBS (bit) | 2 | 4 | 8 | 16 | 18 | 22 | 26 | 30 | 32 | . . . |
| | x | Bandwidth | 1 | 2 | 3 | 4 | 5 | 6 | 7 | 8 | 9 | . . . |
| | symbols | TBS | x | x | x | x | x | x | x | x | x | . . . |
| | . . . | . . . | . . . | . . . | . . . | . . . | . . . | . . . | . . . | . . . | . . . | . . . |

Assuming that the size of the i^{th} TTI is two symbols, and the bandwidth corresponding to the i^{th} TTI is 9 Mbps, it can be found from Table 2 that the size of the to-be-encoded data block corresponding to the i^{th} TTI is 32 bits.

It should be understood that, in the uplink data transmission scenario, the data sending device in the data transmission method in this embodiment may be a network device.

In one embodiment, after determining the time-frequency resources used to transmit the first data, the network device may send information used to indicate the time-frequency resources to a device that is to receive the first data; and/or after determining the transmission parameter used to transmit the second data, send the transmission parameter to a device that is to receive the first data, so that the device that is to receive the first data receives the first data based on the information indicating the time-frequency resources and/or the transmission parameter used to transmit the second data.

The following describes the data transmission method in this embodiment in the uplink data transmission scenario. It should be understood that in the uplink data transmission scenario, the data sending device may be a terminal device.

In one embodiment, in S210, the data sending device may receive first indication information sent by a network device, where the first indication information is used to indicate the time-frequency resources.

In some embodiments, the first indication information may be statically configured or may be dynamically indicated. In one embodiment, the data sending device may receive a higher layer control message sent by the network device. The higher layer control message carries the first indication information. The higher layer control message may be, for example, a system message (system information, SI) or a radio resource control (radio resource control, RRC) message. This is not limited in this embodiment. In another optional embodiment, the data sending device may receive an underlying control message sent by the network device. The underlying control message carries the first indication information. The underlying control message may be, for example, a downlink control message (downlink control information, DCI) or a control format indicator (control format indicator, CFI) message. This is not limited in this embodiment.

In some embodiments, if the transmission parameter obtained by the data sending device includes only the quantity of transmission time intervals TTIs used to transmit the second data, and the size of each TTI, and does not include the first frequency resource used to transmit the second data in each TTI, the first indication information may further include frequency hopping information. The frequency hopping information is used to indicate a distribution status in terms of time of a frequency resource that is in the time-frequency resources and that is used to transmit the second data. The data sending device can determine, based on the frequency hopping information, the first frequency resource used to transmit the second data in each TTI.

In some embodiments, after receiving second indication information that is sent by the network device and that is used to instruct to enable the time-frequency resources to transmit the first data, the data sending device may enable the time-frequency resources, and multiplexes some or all of the time-frequency resources with a device that is to transmit the second data. Correspondingly, if the data sending device does not receive the second indication information, the data sending device may encode and map the first data based on a size of a to-be-encoded data block used to transmit the first data in the prior art.

In one embodiment, in S220, the data sending device may receive the transmission parameter sent by the network device, where the transmission parameter includes at least one of the size of the to-be-encoded data block used to transmit the second data, the quantity of transmission time intervals TTIs used to transmit the second data, the size of each TTI, the first frequency resource used to transmit the second data in each TTI, the time-frequency resource occupied by the control channel in each TTI, and the time-frequency resource occupied by the pilot in each TTI.

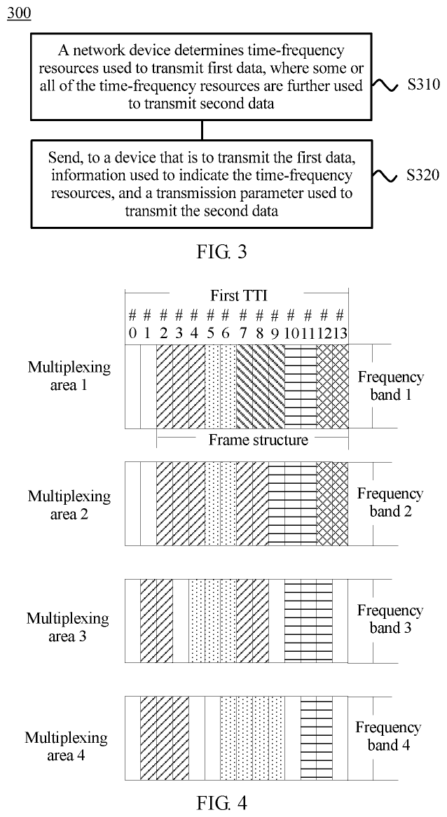

In some embodiments, FIG. 3 is a schematic flowchart of an information transmission method 300 according to an embodiment. The method 300 may be performed, for example, by a network device.

S310. A network device determines time-frequency resources used to transmit first data, where some or all of the time-frequency resources are further used to transmit second data.

S320. The network device sends, to a device that is to transmit the first data, information used to indicate the time-frequency resources, and a transmission parameter used to transmit the second data.

According to the data transmission method provided in this embodiment, after determining the time-frequency resources and the transmission parameter used to transmit the second data, the network device may send, to a terminal device, the transmission parameter and/or the information used to indicate the time-frequency resources, so that the terminal device encodes and maps the first data based on the indication information and the transmission parameter.

In some embodiments, the transmission parameter includes at least one of a size of a to-be-encoded data block used to transmit the second data, a quantity of transmission time intervals TTIs used to transmit the second data, a size of each TTI, a first frequency resource used to transmit the second data in each TTI, a time-frequency resource occupied by a control channel in each TTI, and a time-frequency resource occupied by a pilot in each TTI.

In some embodiments, the network device may add, to different messages, the transmission parameter used to transmit the second data, and send, in a static configuration or dynamic indication manner, the transmission parameter to the device that is to transmit the first data. This is not limited in this embodiment.

In one embodiment, a transmission parameter indication method is provided. The transmission parameter may be jointly indicated by a first message and a second message. The first message is used to indicate a quantity of frequency bands that are used to transmit the second data and that are in a frequency domain resource used to transmit the first data, bandwidth of each frequency band, and a start position of each frequency band. The second message is used to indicate a frame structure that is used to transmit the second data in a frequency domain resource used to transmit the second data. The frame structure includes the quantity of TTIs used to transmit the second data, the size of each TTI, and a start position of each TTI.

For example, FIG. 4 is a schematic diagram of a multiplexed resource according to an embodiment. The first message indicates that a frequency band 1, a frequency band 2, a frequency band 3, and a frequency band 4 in the frequency domain resource used to transmit the first data may be further used to transmit the second data. For example, the first message may carry the quantity of frequency bands, the bandwidth of each frequency band, and the start position of each frequency band. It should be understood that the start position of the frequency band may be indicated by using a start resource block subscript.

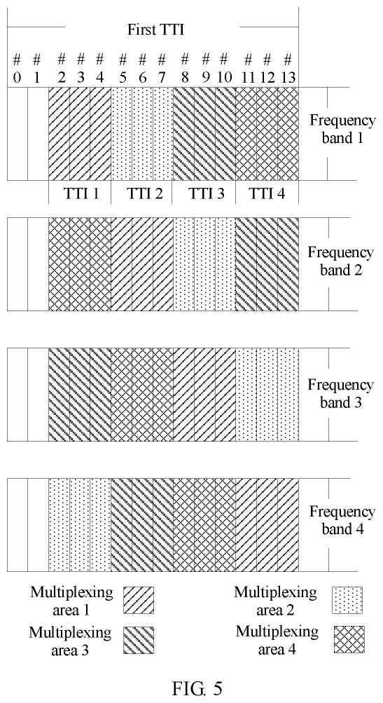

In addition, assuming that one frequency band in FIG. 4 is a multiplexing area, a multiplexing area 1 is used as an example, and the second message is used to indicate a frame structure used to transmit the second data in the frequency band 1. The second message may, for example, carry that the frequency band 1 includes five TTIs, a size of each TTI, and a start position of each TTI. As shown in FIG. 5, in the frequency band 1, a first TTI used to transmit the first data includes 14 symbols numbered 0 to 13. The first TTI includes five TTIs used to transmit the second data. The first of the five TTIs includes three symbols numbered 2, 3, and 4, the second includes two symbols numbered 5 and 6, the third includes three symbols numbered 7, 8, and 9, the fourth includes two symbols numbered 10 and 11, and the fifth includes two symbols numbered 12 and 13. Two symbols numbered 0 and 1 in the first TTI are used to transmit a pilot and/or a control channel of the first data. Similarly, frame structures in a multiplexing area 2, a multiplexing area 3, and a multiplexing area 4 may be learned. Details are not described herein.

In some embodiments, as shown in FIG. 4, a plurality of TTIs included in each frequency band may be continuous or discontinuous in time domain. For example, the five TTIs in the frequency band 1 and five TTIs in the frequency band 2 are continuous in time domain, four TTIs in the frequency band 3 are partially continuous in time domain, and three TTIs in the frequency band 4 are discontinuous in time domain. This is not limited in this embodiment.

In some embodiments, the network device and the device that is to transmit the first data may agree on a plurality of frame structures in advance. In this case, the second message may indicate a frame structure index, and the device that is to transmit the first data may learn, based on the index, the frame structure that is used to transmit the second data in the frequency domain resource used to transmit the second data. This is not limited in this embodiment.

In still another embodiment, this embodiment provides another transmission parameter indication method. The transmission parameter may be jointly indicated by a first message and a second message. The first message is used to indicate the quantity of TTIs used to transmit the second data, the size of each TTI, a start position of each TTI, and the first frequency resource used to transmit the second data in each TTI.

For example, FIG. 5 is a schematic diagram of another multiplexed resource according to an embodiment. The first message is used to indicate that a TTI 1, a TTI 2, a TTI 3, and a TTI 4 in a first TTI used to transmit the first data are further used to transmit the second data. The first message may carry, for example, the quantity of TTIs, the size of each TTI, the start position of each TTI, and the first frequency resource used to transmit the second data in each TTI. As shown in FIG. 5, the TTI 1, the TTI 2, the TTI 3, and the TTI 4 in the first TTI used to transmit the first data are further used to transmit the second data. The TTI 1 includes three symbols numbered 2, 3, and 4. The TTI 2 includes three symbols numbered 5, 6, and 7. The TTI 3 includes three symbols numbered 8, 9, and 10. The TTI 4 includes three symbols numbered 11, 12, and 13. The first message may carry bandwidth and a start position of a frequency band corresponding to each TTI.

In some embodiments, the second message may further carry frequency hopping information. The frequency hopping information is used to indicate a distribution status in terms of time of a frequency resource that is in the time-frequency resources and that is used to transmit the second data.

For example, one TTI in FIG. 5 corresponds to one multiplexing area. For example, in a multiplexing area 1, frequency hopping information of the TTI 1 is used to indicate that a first terminal device occupies a frequency band 1 in the TTI 1, a frequency band 2 in the TTI 2, a frequency band 3 in the TTI 3, and a frequency band 4 in the TTI 4. For example, in a multiplexing area 2, frequency hopping information of the TTI 2 is used to indicate that the first terminal device occupies the frequency band 4 in the TTI 1, the frequency band 1 in the TTI 2, the frequency band 2 in the TTI 3, and the frequency band 3 in the TTI 4. Similarly, time-frequency information distribution indicated by frequency hopping information of a multiplexing area 3 and that of a multiplexing area 4 may be learned. Details are not described herein.

In some embodiments, in the two transmission parameter indication methods in this embodiment, the second message information may further carry the time-frequency resource occupied by the control channel in each TTI and/or the time-frequency resource occupied by the pilot in each TTI. Correspondingly, the device that is configured to transmit the first data may learn, based on the second message, the time-frequency resource occupied by the control channel in each TTI and/or the time-frequency resource occupied by the pilot in each TTI.

In some embodiments, a pilot may be located in a first symbol or a non-first symbol in a TTI, and bandwidth occupied by the pilot may be all or some of bandwidth corresponding to the symbol in which the pilot is located. This is not limited in this embodiment.

For example, FIG. 6 is a schematic structural diagram of a pilot location according to an embodiment (a part shown in a gray shadow in FIG. 6 is a pilot). A first TTI and a second TTI in FIG. 6 each include three symbols. A pilot in the first TTI is located on a first symbol, and a pilot in the second TTI is located on a second symbol. In addition, bandwidth occupied by the pilot in the first TTI is some bandwidth corresponding to the symbol in which the pilot is located, and bandwidth occupied by the pilot in the second TTI is all bandwidth corresponding to the symbol in which the pilot is located. Similarly, time-frequency resources occupied by a pilot in a third TTI and that in a fourth TTI may be learned. Details are not described herein.

In some embodiments, a control channel may be located in a first symbol of a TTI, and bandwidth occupied by the control channel may be all or some of bandwidth corresponding to the symbol in which the control channel is located. This is not limited in this embodiment.

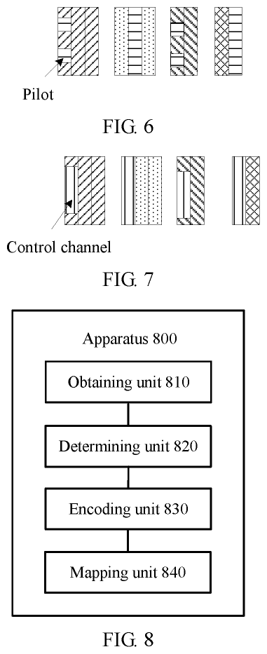

For example, FIG. 7 is a schematic structural diagram of a control channel location according to an embodiment (a part shown in a gray shadow in FIG. 7 is a control channel). A first TTI and a second TTI in FIG. 7 each include three symbols. A control channel in the first TTI is located on a first symbol, and a control channel in the second TTI is located on a second symbol. In addition, bandwidth occupied by the control channel in the first TTI is some bandwidth corresponding to the symbol in which the pilot is located, and bandwidth occupied by the control channel in the second TTI is all bandwidth corresponding to the symbol in which the pilot is located. Similarly, time-frequency resources occupied by a control channel in a third TTI and that in a fourth TTI may be learned. Details are not described herein.

In some embodiments, because a period of an indication of the first message is long and information indicated by the first message changes slowly, and the first message can be statically configured, the first message may be a higher layer control message. The higher layer control message may be, for example, SI or an RRC message. This is not limited in this embodiment.

In some embodiments, because a period of an indication of the second message is short and information indicated by the second message changes quickly, and the information needs to be dynamically indicated, the second message may be an underlying control message. The underlying control message may be, for example, DCI or a CFI message. This is not limited in this embodiment.

According to the data transmission method in this embodiment, the second message information carries the time-frequency resource occupied by the control channel in each TTI and/or the time-frequency resource occupied by the pilot in each TTI, so that symbols occupied by a pilot and/or a control channel of the second data can be avoided when the first data is transmitted. This avoids affecting normal transmission of the second data.

Various embodiments further provide another data transmission method. The method is used by a data receiving end to receive data. The data receiving end may be a terminal device, or may be a network device. This is not limited in this embodiment.

In one embodiment, the data receiving device may obtain time-frequency resources used to transmit first data, where some or all of the time-frequency resources are further used to transmit second data; obtain a transmission parameter used to transmit the second data; determine, based on the transmission parameter, a size of a to-be-decoded data block used to decode the first data; and receive, based on the size of the to-be-decoded data block, a to-be-decoded data block of the first data by using the time-frequency resources.

It should be understood that the to-be-decoded data block received by the data receiving device may be understood as a data block obtained after a data sending device encodes a to-be-encoded data block.

In some embodiments, the transmission parameter may include at least one of a size of a to-be-encoded data block used to transmit the second data, a quantity of TTIs used to transmit the second data, a size of each TTI, a first frequency resource used to transmit the second data in each TTI, a time-frequency resource occupied by a control channel in each TTI, and a time-frequency resource occupied by a pilot in each TTI. This is not limited in this embodiment.

In one embodiment, the transmission parameter may include the size of the to-be-encoded data block used to transmit the second data. The data receiving device may determine, based on the size of the to-be-encoded data block used to transmit the second data, the size of the to-be-decoded data block used to decode the first data; receive, based on the size of the to-be-decoded data block, the to-be-decoded data block of the first data by using the time-frequency resources; and decode the received to-be-decoded data block.

In another embodiment, the transmission parameter may include the quantity of TTIs used to transmit the second data, the size of each TTI and the first frequency resource used to transmit the second data in each TTI. The data receiving device may determine, based on the size of each TTI and the first frequency resource used to transmit the second data in each TTI, a size of a to-be-encoded data block corresponding to each TTI, and use the size of the to-be-encoded data block corresponding to each TTI as the size of the to-be-decoded data block used to decode the first data.

According to the data transmission methods in the various embodiments, the data sending device determines the size of the to-be-encoded data block of the eMBB data based on the transmission status of the URLLC data, and encodes and maps the eMBB data based on the size of the to-be-encoded data block of the eMBB data. In this case, on the multiplexed part of the physical resource, the size of the to-be-encoded data block of the eMBB data can better match the size of the to-be-encoded data block of the URLLC data. Therefore, when the data receiving device decodes the eMMB data, interference of the URLLC data in the eMBB data is limited to a relatively small data range. This reduces the interference of the URLLC data in the eMBB data.

In addition, when decoding a code block of the URLLC data, a code block of the eMBB data that interferes with the code block needs to be read. Because on the multiplexed part of the physical resource, the size of the to-be-encoded data block of the eMBB data can better match the size of the to-be-encoded data block of the URLLC data, a size of the code block of the eMBB data can also better match a size of the code block of the URLLC data. This reduces a decoding delay generated when the code block of the URLLC data is being decoded.

The foregoing describes in detail the data transmission methods according to the various embodiments with reference to FIG. 1 to FIG. 7. The following describes in detail data transmission apparatuses according to the various embodiments with reference to FIG. 8 to FIG. 11.

FIG. 8 shows a data transmission apparatus 800 according to an embodiment. The apparatus 800 includes:

an obtaining unit 810, configured to: obtain time-frequency resources used to transmit first data, where some or all of the time-frequency resources are further used to transmit second data; and obtain a transmission parameter used to transmit the second data;

a determining unit 820, configured to determine, based on the transmission parameter obtained by the obtaining unit, a size of a to-be-encoded data block used to encode the first data;

an encoding unit 830, configured to encode the first data based on the size of the to-be-encoded data block determined by the determining unit; and

a mapping unit 840, configured to map a data block obtained by the encoding unit through the encoding to the time-frequency resources.

In some embodiments, the transmission parameter includes at least one of a size of a to-be-encoded data block used to transmit the second data, a quantity of transmission time intervals TTIs used to transmit the second data, a size of each TTI, a first frequency resource used to transmit the second data in each TTI, a time-frequency resource occupied by a control channel in each TTI, and a time-frequency resource occupied by a pilot in each TTI.

In some embodiments, the determining unit is configured to: determine, based on the size of each TTI and the first frequency resource used to transmit the second data in each TTI, a size of a to-be-encoded data block corresponding to each TTI; and determine, based on the size of the to-be-encoded data block corresponding to each TTI, the size of the to-be-encoded data block used to encode the first data.

In some embodiments, the determining unit is further configured to: before the determining, based on the size of the to-be-encoded data block corresponding to each TTI, the size of the to-be-encoded data block used to encode the first data, determine, based on the first frequency resource used to transmit the second data in each TTI, a second frequency resource that is in the time-frequency resources and that is not used to transmit the second data; and determine, based on the second frequency resource and TTIs corresponding to the time-frequency resources, a size of a to-be-encoded data block used to encode data that is in the first data and that is transmitted by using the second frequency resource. Correspondingly, the determining unit is specifically configured to determine, based on the size of the to-be-encoded data block corresponding to each TTI and the size of the to-be-encoded data block used to encode the data that is in the first data and that is transmitted by using the second frequency resource, the size of the to-be-encoded data block used to encode the first data.

In some embodiments, the determining unit is specifically configured to: determine, based on a first frequency resource used to transmit the second data in an i^{th} TTI in the TTIs, a size of a to-be-encoded data block corresponding to a reference TTI when the i^{th} TTI corresponds to a size of the reference TTI, where i is an integer greater than 0; and determine, based on the size of the to-be-encoded data block corresponding to the reference TTI and a size of the i^{th} TTI, a size of a to-be-encoded data block corresponding to the i^{th} TTI.

In some embodiments, the size of the to-be-encoded data block corresponding to the i^{th} TTI is N_{i-CBS}, and the determining unit is specifically configured to determine N_{i-CBS} according to the following formula:

N_{i-CBS}=floor(N_{j-CBS}·N_{i-OS}/N_{j-OS}), where

N_{j-OS} is the size of the reference TTI, N_{i-OS} is the size of the i^{th} TTI, N_{j-CBS} is the size of the to-be-encoded data block corresponding to the reference TTI, and floor (.) indicates rounding down.

In some embodiments, the determining unit is configured to determine, based on a size of an i^{th} TTI in the TTIs, a first frequency resource used to transmit the second data in the i^{th} TTI, and a pre-stored first mapping relationship, a size of a to-be-encoded data block corresponding to the i^{th} TTI, where the first mapping relationship includes a mapping relationship between a size of a TTI and a frequency resource and a size of a to-be-encoded data block, and i is an integer greater than 0.

In the foregoing embodiment, the data transmission apparatus 800 may be the network device 110, the terminal device 120, or the terminal device 130.

In some embodiments, the obtaining unit is specifically configured to receive first indication information sent by a network device. The first indication information is used to indicate the time-frequency resources. In this embodiment, the data transmission apparatus 800 is specifically the terminal device 120 or the terminal device 130.

In some embodiments, the first indication information includes frequency hopping information. The frequency hopping information is used to indicate a distribution status in terms of time of a frequency resource that is in the time-frequency resources and that is used to transmit the second data. In this embodiment, the data transmission apparatus 800 is specifically the terminal device 120 or the terminal device 130.

In some embodiments, the obtaining unit is configured to receive the transmission parameter sent by the network device. In this embodiment, the data transmission apparatus 800 is specifically the terminal device 120 or the terminal device 130.

In some embodiments, the obtaining unit is further configured to receive second indication information sent by the network device. The second indication information is used to instruct to enable the time-frequency resources to transmit the first data. In this embodiment, the data transmission apparatus 800 is specifically the terminal device 120 or the terminal device 130.

In some embodiments, the apparatus may include a sending unit (not shown in this example). The sending unit is configured to send, to a device that is to receive the first data, information used to indicate the time-frequency resources; and/or send the transmission parameter to the device that is to receive the first data. In this embodiment, the data transmission apparatus 800 is specifically the network device 110.

In an example, a person skilled in the art may understand that the apparatus 800 may be specifically the data sending device in the foregoing method embodiment. The apparatus 800 may be configured to perform procedures and/or steps corresponding to the data sending device in the foregoing method embodiment. To avoid repetition, details are not described herein again.

It should be understood that the apparatus 800 herein may be presented in a form of a functional unit. The term “unit” herein may indicate an application-specific integrated circuit (application-specific integrated circuit, ASIC), an electronic circuit, a processor (for example, a shared processor, a dedicated processor, or a group processor) configured to execute one or more software or firmware programs and a memory, a combined logic circuit, and/or another proper component that supports a described function.

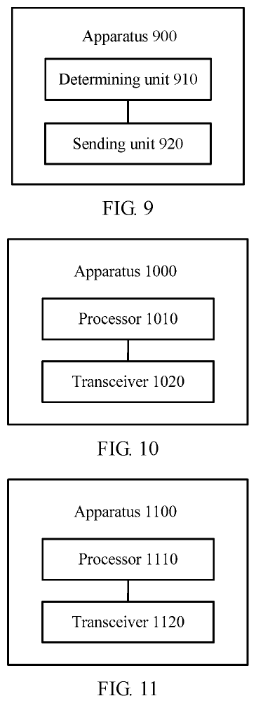

FIG. 9 shows an information transmission apparatus 900 according to an embodiment. The apparatus 900 includes:

a determining unit 910, configured to determine time-frequency resources used to transmit first data, where some or all of the time-frequency resources are further used to transmit second data; and

a sending unit 920, configured to send, to a device that is to transmit the first data, information that is used to indicate the time-frequency resources and that is determined by the determining unit, and a transmission parameter used to transmit the second data.

In some embodiments, the transmission parameter includes at least one of a size of a to-be-encoded data block used to transmit the second data, a quantity of transmission time intervals TTIs used to transmit the second data, a size of each TTI, a first frequency resource used to transmit the second data in each TTI, a time-frequency resource occupied by a control channel in each TTI, and a time-frequency resource occupied by a pilot in each TTI.

In an example, a person skilled in the art may understand that the apparatus 900 may be the network device in the foregoing method embodiment. The apparatus 900 may be configured to perform procedures and/or steps corresponding to the network device in the foregoing method embodiment. To avoid repetition, details are not described herein again.

It should be understood that the apparatus 900 herein may be presented in a form of a functional unit. The term “unit” herein may indicate an application-specific integrated circuit (ASIC), an electronic circuit, a processor (for example, a shared processor, a dedicated processor, or a group processor) configured to execute one or more software or firmware programs and a memory, a combined logic circuit, and/or another proper component that supports a described function.

FIG. 10 is a schematic block diagram of a data transmission apparatus 1000 according to an embodiment. As shown in FIG. 10, the apparatus 1000 includes a processor 1010 and a transceiver 1020.

The processor 1010 is configured to: obtain time-frequency resources used to transmit first data, where some or all of the time-frequency resources are further used to transmit second data; obtain a transmission parameter used to transmit the second data; determine, based on the transmission parameter, a size of a to-be-encoded data block used to encode the first data; and encode the first data based on the size of the to-be-encoded data block.

The transceiver 1020 is configured to map a data block obtained by the encoding unit through the encoding to the time-frequency resources.

In some embodiments, the apparatus 1000 may further include a memory. The memory may include a read-only memory and a random access memory, and provide an instruction and data for the processor. A part of the memory may further include a non-volatile random access memory. For example, the memory may further store information of a device type. The processor 1010 may be configured to execute the instruction stored in the memory, and when the processor executes the instruction, the processor may perform steps corresponding to the terminal device in the foregoing method embodiment.

It should be understood that in this embodiment, the processor may be a central processing unit (central processing unit, CPU), the processor may alternatively be another general purpose processor, a digital signal processor (digital signal processor, DSP), an application-specific integrated circuit ASIC, a field programmable gate array (field programmable gate array, FPGA) or another programmable logic device, a discrete gate or a transistor logic device, a discrete hardware component, or the like. The general purpose processor may be a microprocessor, or the processor may be any conventional processor or the like.

FIG. 11 is a schematic block diagram of an information transmission apparatus 1100 according to an embodiment. As shown in FIG. 11, the apparatus 1100 includes a processor 1110 and a transceiver 1120.

The processor 1110 is configured to determine time-frequency resources used to transmit first data, where some or all of the time-frequency resources are further used to transmit second data.

The transceiver 1120 is configured to send, to a device that is to transmit the first data, information that is used to indicate the time-frequency resources and that is determined by the determining unit, and a transmission parameter used to transmit the second data.

In some embodiments, the apparatus 1100 may further include a memory. The memory may include a read-only memory and a random access memory, and provide an instruction and data for the processor. A part of the memory may further include a non-volatile random access memory. For example, the memory may further store information of a device type. The processor 1110 may be configured to execute the instruction stored in the memory, and when the processor executes the instruction, the processor may perform steps corresponding to the network device in the foregoing method embodiment.

It should be understood that in this embodiment, the processor may be a central processing unit (CPU), or the processor may be another general purpose processor, a digital signal processor (DSP), an application-specific integrated circuit (ASIC), a field programmable gate array (FPGA) or another programmable logic device, a discrete gate or a transistor logic device, a discrete hardware component, or the like. The general purpose processor may be a microprocessor, or the processor may be any conventional processor or the like.

In an implementation process, steps in the foregoing methods can be implemented by using a hardware integrated logical circuit in the processor, or by using instructions in a form of software. The steps of the method disclosed with reference to the various embodiments may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, a register, or the like. The storage medium is located in the memory, and the processor executes instructions in the memory and completes the steps in the foregoing methods in combination with hardware of the processor. To avoid repetition, details are not described herein again.

It should be understood that the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that sequence numbers of the foregoing processes do not mean execution sequences in various various embodiments. The execution sequences of the processes should be determined based on functions and internal logic of the processes, and should not constitute any limitation on the implementation processes of the various embodiments.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for detailed working processes of the foregoing system, apparatus, and unit, reference may be made to corresponding processes in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the various embodiments may be integrated into one processing unit, or each of the units may exist alone physically, or two or more units are integrated into one unit.

All or some of the foregoing embodiments may be implemented by software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the various embodiments are all or partially generated. The computer may be a general-purpose computer, a dedicated computer, a computer network, or another programmable apparatus. The computer instructions may be stored in a computer readable storage medium or may be transmitted from one computer readable storage medium to another computer readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, microwave, or the like) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD), a semiconductor medium (for example, a solid-state drive (solid state disk, SSD)), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A data transmission method, comprising:
obtaining time-frequency resources for transmitting first data, wherein some or all of the time-frequency resources are further for transmitting second data;
obtaining a transmission parameter for transmitting the second data;
determining, based on the transmission parameter, a size of a to-be-encoded data block for encoding the first data;
encoding the first data based on the size of the to-be-encoded data block; and
mapping a data block obtained through the encoding to the time-frequency resources.

2. The method according to claim 1, wherein the transmission parameter comprises at least one of a size of a to-be-encoded data block for transmitting the second data, a quantity of transmission time intervals TTIs for transmitting the second data, a size of each TTI, a first frequency resource for transmitting the second data in each TTI, a time-frequency resource occupied by a control channel in each TTI, and a time-frequency resource occupied by a pilot in each TTI.

3. The method according to claim 2, wherein determining, based on the transmission parameter, the size of a to-be-encoded data block used to encode the first data comprises:
determining, based on the size of each TTI and the first frequency resource for transmitting the second data in each TTI, a size of a to-be-encoded data block corresponding to each TTI; and
determining, based on the size of the to-be-encoded data block corresponding to each TTI, the size of the to-be-encoded data block used to encode the first data.

4. The method according to claim 3, wherein before determining, based on the size of the to-be-encoded data block corresponding to each TTI, the size of the to-be-encoded data block for encoding the first data, the method further comprises:
determining, based on the first frequency resource for transmitting the second data in each TTI, a second frequency resource that is in the time-frequency resources and that is not for transmitting the second data; and
determining, based on the second frequency resource and TTIs corresponding to the time-frequency resources, a size of a to-be-encoded data block for encoding data that is in the first data and that is transmitted by using the second frequency resource; and, wherein
determining, based on the size of the to-be-encoded data block corresponding to each TTI, the size of the to-be-encoded data block for encoding the first data comprises:
determining, based on the size of the to-be-encoded data block corresponding to each TTI and the size of the to-be-encoded data block for encoding the data in the first data and transmitted by the second frequency resource, the size of the to-be-encoded data block for encoding the first data.

5. The method according to claim 3, wherein determining, based on the size of each TTI and the first frequency resource for transmitting the second data in each TTI, a size of a to-be-encoded data block corresponding to each TTI comprises:
determining, based on a first frequency resource for transmitting the second data in an i^{th} TTI in the TTIs, a size of a to-be-encoded data block corresponding to a reference TTI when the i^{th} TTI corresponds to a size of the reference TTI, wherein i is an integer greater than 0; and
determining, based on the size of the to-be-encoded data block corresponding to the reference TTI and a size of the i^{th} TTI, a size of a to-be-encoded data block corresponding to the i^{th} TTI.

6. The method according to claim 5, wherein the size of the to-be-encoded data block corresponding to the i^{th} TTI is N_{i-CBS}, and N_{i-OS} is determined according to the following formula:
N_{i-CBS}=floor(N_{j-CBS}·N_{i-OS}/N_{j-OS}), wherein
N_{j-OS} is the size of the reference TTI, N_{i-OS} is the size of the i^{th} TTI, N_{j-CBS} is the size of the to-be-encoded data block corresponding to the reference TTI, and floor(·) indicates rounding down.

7. The method according to claim 3, wherein the determining, based on the size of each TTI and the first frequency resource for transmitting the second data in each TTI, a size of a to-be-encoded data block corresponding to each TTI comprises:
determining, based on a size of an i^{th} TTI in the TTIs, a first frequency resource for transmitting the second data in the i^{th} TTI, and a pre-stored first mapping relationship, a size of a to-be-encoded data block corresponding to the i^{th} TTI, wherein the first mapping relationship comprises a mapping relationship between a size of a TTI and a frequency resource and a size of a to-be-encoded data block, and i is an integer greater than 0.

8. The method according to claim 1, wherein obtaining time-frequency resources for transmitting the first data comprises:
receiving first indication information sent by a network device, wherein the first indication information indicates the time-frequency resources.

9. The method according to claim 8, wherein the first indication information comprises frequency hopping information, wherein the frequency hopping information indicates a distribution status in terms of time of a frequency resource in the time-frequency resources for transmitting the second data.

10. The method according claim 1, wherein obtaining the transmission parameter for transmitting the second data comprises: receiving the transmission parameter sent by the network device.

11. The method according to claim 1, wherein the method further comprises:
receiving second indication information sent by the network device, wherein the second indication information is configured for instructing to enable the time-frequency resources to transmit the first data.

12. The method according to claim 1, wherein the method further comprises:
sending, to a device that is to receive the first data, information indicating the time-frequency resources; and/or
sending the transmission parameter to the device that is to receive the first data.

13. An information transmission method, comprising:
determining, by a network device, time-frequency resources for transmitting first data, wherein some or all of the time-frequency resources are further for transmitting second data; and
sending, to a device that is to transmit the first data, information indicating the time-frequency resources, and a transmission parameter for transmitting the second data.

14. The method according to claim 13, wherein the transmission parameter comprises:
at least one of a size of a to-be-encoded data block for transmitting the second data, a quantity of transmission time intervals TTIs for transmitting the second data, a size of each TTI, a first frequency resource for transmitting the second data in each TTI, a time-frequency resource occupied by a control channel in each TTI, and a time-frequency resource occupied by a pilot in each TTI.

15. A data transmission apparatus, comprising:
an obtaining unit, configured to: obtain time-frequency resources for transmitting first data, wherein some or all of the time-frequency resources are further for transmitting second data; and obtain a transmission parameter for transmitting the second data;
a determining unit, configured to determine, based on the transmission parameter obtained by the obtaining unit, a size of a to-be-encoded data block for encoding the first data;
an encoding unit, configured to encode the first data based on the size of the to-be-encoded data block determined by the determining unit; and
a mapping unit, configured to map a data block obtained by the encoding unit through the encoding to the time-frequency resources.

16. The apparatus according to claim 15, wherein the transmission parameter comprises at least one of a size of a to-be-encoded data block for transmitting the second data, a quantity of transmission time intervals TTIs for transmitting the second data, a size of each TTI, a first frequency resource for transmitting the second data in each TTI, a time-frequency resource occupied by a control channel in each TTI, and a time-frequency resource occupied by a pilot in each TTI.

17. The apparatus according to claim 16, wherein the determining unit is configured to:
determine, based on the size of each TTI and the first frequency resource for transmitting the second data in each TTI, a size of a to-be-encoded data block corresponding to each TTI; and
determine, based on the size of the to-be-encoded data block corresponding to each TTI, the size of the to-be-encoded data block for encoding the first data.

18. The apparatus according to claim 17, wherein the determining unit is further configured to:
before determining, based on the size of the to-be-encoded data block corresponding to each TTI, the size of the to-be-encoded data block for encoding the first data, determine, based on the first frequency resource for transmitting the second data in each TTI, a second frequency resource in the time-frequency resources, the second frequency resource being not for transmitting the second data; and
determine, based on the second frequency resource and TTIs corresponding to the time-frequency resources, a size of a to-be-encoded data block for encoding data that is in the first data and that is transmitted by using the second frequency resource; and, wherein,
determining unit is further configured to determine, based on the size of the to-be-encoded data block corresponding to each TTI and the size of the to-be-encoded data block for encoding the data that is in the first data and that is transmitted by using the second frequency resource, the size of the to-be-encoded data block for encoding the first data.

19. The apparatus according to claim 17, wherein determining unit is further configured to:
determine, based on a first frequency resource for transmitting the second data in an i^{th} TTI in the TTIs, a size of a to-be-encoded data block corresponding to a reference TTI when the i^{th} TTI corresponds to a size of the reference TTI, wherein i is an integer greater than 0; and
determine, based on the size of the to-be-encoded data block corresponding to the reference TTI and a size of the i^{th} TTI, a size of a to-be-encoded data block corresponding to the i^{th} TTI.

20. The apparatus according to claim 19, wherein the size of the to-be-encoded data block corresponding to the i^{th} TTI is N_{i-CBS}, and the determining unit is configured to determine N_{i-CBS} according to the following formula:
N_{i-CBS}=floor(N_{j-CBS}·N_{i-OS}/N_{j-OS}), wherein
N_{j-OS} is the size of the reference TTI, N_{i-OS} is the size of the i^{th} TTI, N_{j-CBS} is the size of the to-be-encoded data block corresponding to the reference TTI, and floor(·) indicates rounding down.
